(19) United States
(12) Patent Application Publication
(10) Pub. No.: US 2015/0046282 A1
(43) Pub. Date: Feb. 12, 2015

(54) System and Methods that Allow Customers to Order a Payment Sticker from a Provider

(71) Applicant: Kevin Michael Sullivan, Wilmington, DE (US)

(72) Inventor: Kevin Michael Sullivan, Wilmington, DE (US)

(21) Appl. No.: 13/962,874

(22) Filed: Aug. 8, 2013

(51) Int. Cl. G06Q 30/06; G06Q 20/32; G06Q 20/36

(52) U.S. Cl. CPC G06Q 30/0633; G06Q 20/367; G06Q 20/3278
USPC 705/26.8

(57) ABSTRACT

A process that allows consumers to order Near Field Communication (NFC) payment stickers directly from a provider using the internet, mobile smart telephone, email, regular mail or other channels. The process allows the consumer to express the desire, validate their identity, provide delivery instructions and authorize a payment for the stickers. The patent application describes a method to administer such a program by a provider that ensures accuracy, completion of the consumer request and allows the provider to benefit from the revenue opportunity, cost reduction, retention and loyalty benefits of offering such a service.

### REFERENCES CITED

U.S. Patent Documents

| | | | |
|---|---|---|---|
| 7,784,684 | Date | Labrou et al. | 11/488,178 |
| 8,275,312 | Date | Fisher, et al | 11/933,321 |
| 8,290,433 | Date | Fisher et al. | 11/939,821 |

### Other Documents

Gigaom, Mar. 30, 2009, “Can Stickers Drive Mobile Payments?”
Payments News, Mar. 19, 2009, MasterCard Announces Issuance of 50 Millionth PayPass Card.”
Payments Source, Jun. 10, 2010, “Citibank Begins Offering Customers Contactless-Payment Stickers.”
American Banker, Jun. 7, 2011, “Bling Nation's Business Model Doesn't Quite Stick.”
American Banker, Jul. 20, 2011, “Mobile Too Complex? Some Revive Simpler Payment Forms.
Bank Technology News, Aug. 1, 2011, Seven Technologies Behind Mobile Payments.”
Bank Technology News, Sep. 5, 2011, “Why Great Mobile Payment Ideas Die Young.”
Mobile Payments Today, Dec. 4, 2012, “La Caixa to roll out mobile payment stickers in Barcelona.”

### FIELD OF THE INVENTION

The present invention relates generally to a system and method for offering customers of a financial services provider with a way to allow consumers to self-identify as a customer who would like a payment sticker and a way to order and receive the sticker.

### INTRODUCTION

Some consumers would like the convenience and ease of paying for goods and services using their mobile telephone or tablet—instead of by using a card with a mag stripe as the access and verification vehicle to utilize an existing credit, debit or pre-paid account. Banks are distributing small stickers to existing customers that can be placed on the face, back or inside a mobile phone that include Near Field Communications (NFC) technology that, when properly coded with deposit, stored value or credit account payment information, can be used with enabled merchant payment terminals to initiate authorization, clearing and settlement—and complete a purchase. Banks do not know which of their consumers want this capability. To address this need, a process that allows consumers to order payment stickers directly from a provider using the internet, telephone, email, regular mail or other channels has been created. The process allows the consumer to express the desire, validate their identity, provide delivery instructions and authorize a payment for the stickers if the bank is charging for this service. By allowing consumers to self-identify as wanting this service and offering a way to self-service the order, consumers who want this mobile commerce option will be able to get it—driving faster adoption of mobile device payments and the resulting increased sales, efficiency, customer loyalty and marketing benefits for merchants and payment product issuers; and the convenience opportunities for consumers. With more mobile payment options, consumer will be able to receive more discount, loyalty and reward offers from merchants. This process benefits payment providers because they will not need to issue payment stickers in mass to an entire portfolio of payment product users or a broad sub-set—based on known characteristics that may indicate a desire for such a service—but often result in expense without business return because consumers who receive the stickers don't use them. The patent application describes a method to administer such a program by a provider that ensures accuracy, completion of the consumer request and allows the provider to benefit from the revenue opportunity, cost reduction, retention and loyalty benefits of offering such a service.

### BACKGROUND OF THE INVENTION

Consumers are increasingly using mobile devices to initiate a payment to a merchant for goods and services rather than a plastic or metal card that contains the account number embossed on the card face and a method, such as a magnetic stripe or electronic chip to store and communicate the account number, expiration date, consumer's name and other information via an electronic device at the merchant such as a card-reading point of sale device or electronic register. Such mobile device payments allow ease of use, convenience, the ability to carry fewer items around on one's person, the ability to view transaction or reward account information immediately before or after a purchase, the ability to initiate service requests for the payment account on the same device as the one used for payment and the ability to receive marketing offers such as discounts and the awarding or reward points via the mobile device.

Payments on a mobile device can be initiated via a near field communications (NFC) technology transponder embedded in the device, a Quick Response Code (QR) Code reader that receives a signal from the merchant terminal or register and communicates to receive the transaction authorization from the payment provider via cloud computing or other technologies.

Such NFC capability has also been attached to plastic cards (credit card, debit card, pre-paid card) in the form of a small transponder and is being used by consumers globally to make payments at NFC-enabled merchant point of sale terminals.

Enabling a mobile telephone, tablet or device to be able to initiate a payment against a debit, credit or pre-paid account via near field communications technology requires specific NFC-enabling hardware, QR code or bar code reading capability to be imbedded in the device during manufacturing or as an after-market addition within the console or case. This requirement has added cost and complexity into the development of this payment process and has slowed adoption by mobile telephone and hand-held-device makers and providers.

By simply adding a small, programmed NFC-enabled transponder on the surface of the hand-held device via adhesive strip, glue or mounting hardware, expense and complexity is avoided. Payment stickers are gaining in popularity and are being issued by financial services providers such as credit card, debit card, ACH account and pre-paid account providers to their customers to allow them to use their hand-held device as an NFC-enabled payment device at the merchant point of sale. This service affords the customer convenience and drives the use of the institution's payment account which results in merchant interchange income, the amount paid by the merchant and removed from the transaction at settlement at the expense of the merchant and can also drive per-transaction fees charged to the consumer, interest charges if the consumer revolves the transaction amount on a credit card account and increased loyalty from the consumer who may enjoy the convenience and seek to use that particular account with greater frequency.

The financial institution incurs an expense to manufacture or purchase the payment sticker and distribute it to customers. Financial services providers attempt to reduce expense by selectively issuing the payment sticker to customers based on data profiling such as home address being located near a preponderance of merchants that offer NFC-enabled payment terminals and demonstrated high frequency of usage at merchants that are more likely to offer NFC-enabled payment terminals such as convenience stores, supermarkets, petroleum sellers and quick service restaurants. Financial services providers also attempt to identify customers who would value NFC capability by analyzing credit worthiness scores, zip code and other data elements housed on their Customer Relationship Management (CRM) database systems.

Payment account issuers will benefit from a lower cost method of identifying existing customers who will utilize NFC functionality for payments on a mobile device, administering the process and distributing the stickers to customers. By doing this, financial institution payment account issuers will receive the financial advantages to be gained from greater loyalty and persistency of the customers who use and value the service and incoming revenue related to transactions made using the sticker. Financial institutions will also benefit by only issuing the stickers to customers with a propensity to use them and therefore reducing the business expense of issuing stickers to broader populations and the related per-item expense of each shipment which includes the sticker or stickers and printed instructions and promotional material.

### SUMMARY OF THE INVENTION

It is one object of the present invention to overcome one or more of the aforementioned and other limitations of existing systems and methods for the use of issuing payment stickers by financial institutions.

What is desired is a system and method of allowing existing customers with a predeliction for using payment stickers to request this service on a self-serve basis and therefore limit the expense to the payment account issuer for fulfillment of payment stickers by limiting marketing expense and only shipping to those who have indicated they desire the feature and will use it.

It is another object of the invention to provide a system and method that exists on the Internet to describe the service and receive and track customer requests so that the payment account issuer will receive the financial benefits of customers using the service.

It is another object of the invention to provide a system and method to initiate an order for shipping using the provider's computer systems.

It is another object of the invention to provide a system and method to perform a systemic check on the status of the customer to ensure no major payment delinquencies, fraud account holds or other reasons to delay the order or not accept the order.

It is another object of the invention to provide a system and method to ensure a systemic request is made to have a payment sticker programmed with the data needed to complete transaction (account holder name, account number, account expiration date, security code) using RFID or NFC technology by the Financial Institution or a secure printer who provides this service.

It is another object of the invention to provide a system and method to receive and track validation that the shipping order was received and that the payment sticker was shipped to the customer.

It is another object of the invention to provide a system and method to use the system to track the status of the payment sticker order and allow the system to be leveraged for status inquiries by personnel managing the process and providing customer service.

It is another object of the invention to provide a system and method to use the system to ensure issuance of new payment stickers before the expiration date related to the plastic card linked to the account so that customers receive an updated payment sticker before it expires.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is a block diagram illustrating how the financial institution makes available via the internet and visible on personal computers, tablets and mobile devices information and compelling graphics describing the benefits of payment stickers and allows the consumer to order one or more payment stickers linked to their account.

FIG. 2 is a block diagram illustrating how the financial institution makes available via telephone request from the consumer an order for one or more payment stickers linked to their account.

FIG. 3 is a block diagram illustrating a method according to an embodiment of the invention for providing a system to issue replacement payment stickers before or at expiration of the previous sticker.

### DETAILED DESCRIPTION OF THE INVENTION

As discussed in the Summary of the Invention, the present invention is directed to a method and apparatus for a payment instrument that is associated with a consumer's deposit, credit or pre-paid account, whereby the consumer can request or order a payment sticker to attach to a mobile device to use to make payments at merchants that accept contactless RFID or NFC payment devices. This self-selection by the customer allows the financial institution to save the expense of issuing such stickers to entire portfolios or groups of customers who will not utilize the device.

Overview of the Invention According to One Embodiment: Digital

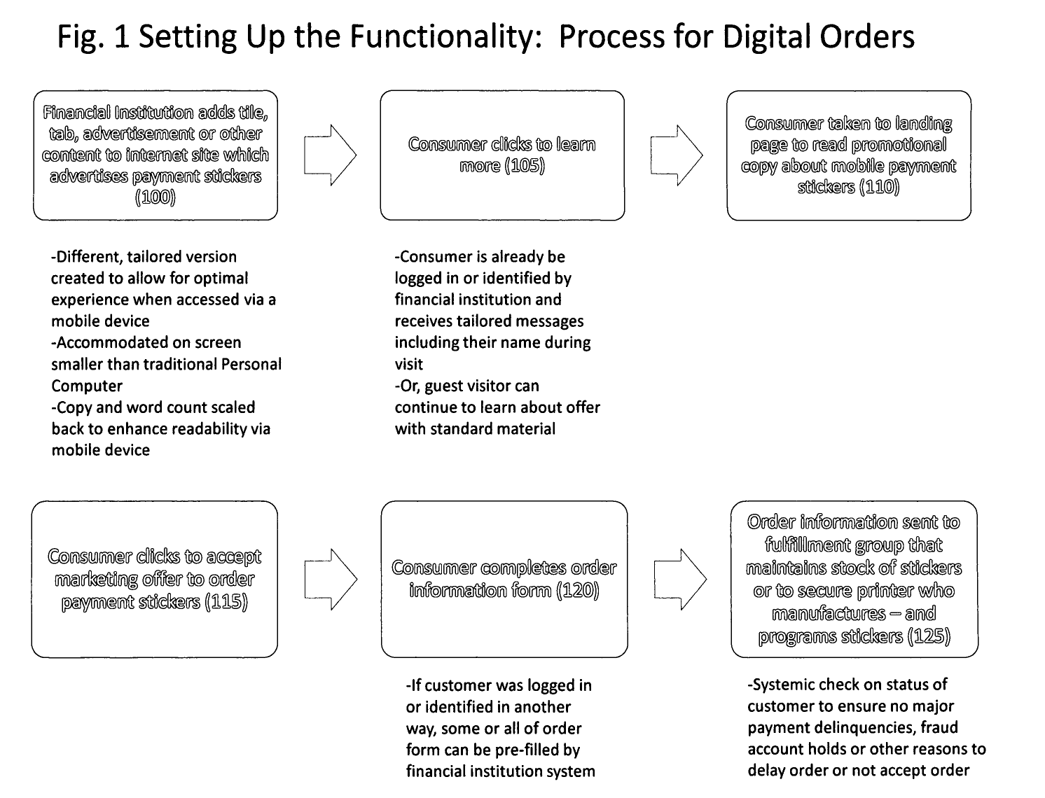

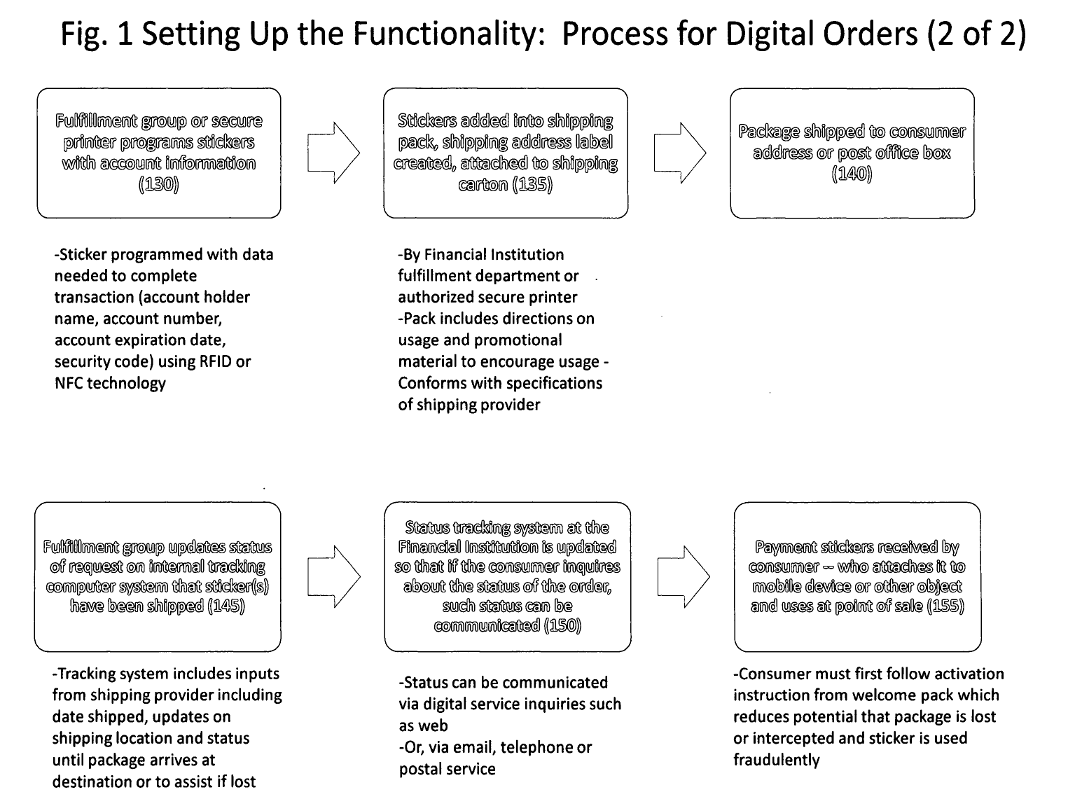

FIG. 1 provides an overview of how the financial institution makes available via the internet and visible on personal computers, tablets and mobile devices information and compelling graphics describing the benefits of payment stickers and allows the consumer to order one or more payment stickers linked to their account.

To increase awareness about the service, 100 the financial Institution adds a tile, tab, banner, pop-up message, advertisement or other content to its internet site which advertises payment stickers. Different, tailored versions are created to allow for optimal experience when accessed via a mobile device which can be accommodated on screen smaller than traditional Personal Computer. In this case, copy and word count are scaled back to enhance readability via mobile device. The consumer clicks 105 on the ad and is taken to a landing page 110 to learn more. If the Consumer is already logged in or identified by the financial institution electronically, they can be exposed to tailored digital messages during the visit. Or, they can continue as a guest visitor to learn about the offer with standardized material that does not leverage known preferences of the customer.

After reviewing promotional material and information about the offer, the consumer acknowledges digitally they would like to receive and use payment stickers for purchases at the point of sale 115. This is facilitated via a digital authorization mechanism that includes disclosures the financial institution seeks to ensure are understood by the consumer. A confirming application is presented to the consumer to confirm the address where the stickers should be shipped 120. The financial institution can check against its customer database to ensure this is the same address for the consumer it has on file and if not can decline to proceed with the order or contact the customer separately via digital channel or telephone to validate they seek this service and the inquiry is not fraudulent. If the customer was logged in or identified in another way before moving to accept the offer, some or all of the order form can be pre-filled by the financial institution system with known information about the consumer for ease of usage and to expedite the order process.

A systemic inquiry is completed on the status of the customer to ensure no major payment delinquencies, fraud account holds or other reasons to delay the order for additional investigation exist or not accept the order entirely. Information about the order including identification of the customer is sent to the financial institution's fulfillment group that maintains stock of stickers or to secure printer, contracted by the financial institution, who manufactures payment stickers 125. The customer is identified and the fulfillment group has access to customer information needed to fulfill the order which includes name, address and payment account number. Stickers are programmed 130 to be used by the particular consumer to include account holder name, account number, account expiration date, security validation code).

Stickers are added into shipping pack by the financial institution's fulfillment department or an authorized secure printer under contract with the financial institution. A shipping address label is created and attached to shipping carton 135. The pack includes directions on usage and promotional material to encourage usage and conforms to the specifications of the shipping services provider.

The package with sticker or stickers is shipped to the consumer's specified address or a post office box 140.

The fulfillment group updates the status of the request via the internal tracking computer system that the sticker(s) have been shipped 145. The tracking system includes electronic shipping status update inputs from the shipping provider including date shipped, last location and expected delivery date—until the package arrives at destination or to assist if misplaced. The status tracking system at the Financial Institution is updated 150 so that if the consumer inquires about the status of the order, such status can be communicated. This status can be communicated via digital service inquiries such as web email, and by telephone or postal service delivered correspondence.

The Payment stickers are received by the customer(s) 155. As instructed in promotional material that accompanies the shipment of stickers, the customer then attaches it to a mobile device or other object and uses it at an NFC-enabled point of sale terminal to make a purchase. The customer must first follow activation instructions from the welcome pack which reduces the potential that the package is lost or intercepted and the sticker is used fraudulently.

The provider can elect to charge a fee to the customer for receiving the payment sticker. This can be a one-time charge for issuance of the sticker, an annual fee assessed each year that the sticker is being used by the consumer or a per-transaction fee which is assessed each time the consumer uses the payment sticker.

### Telephone Orders

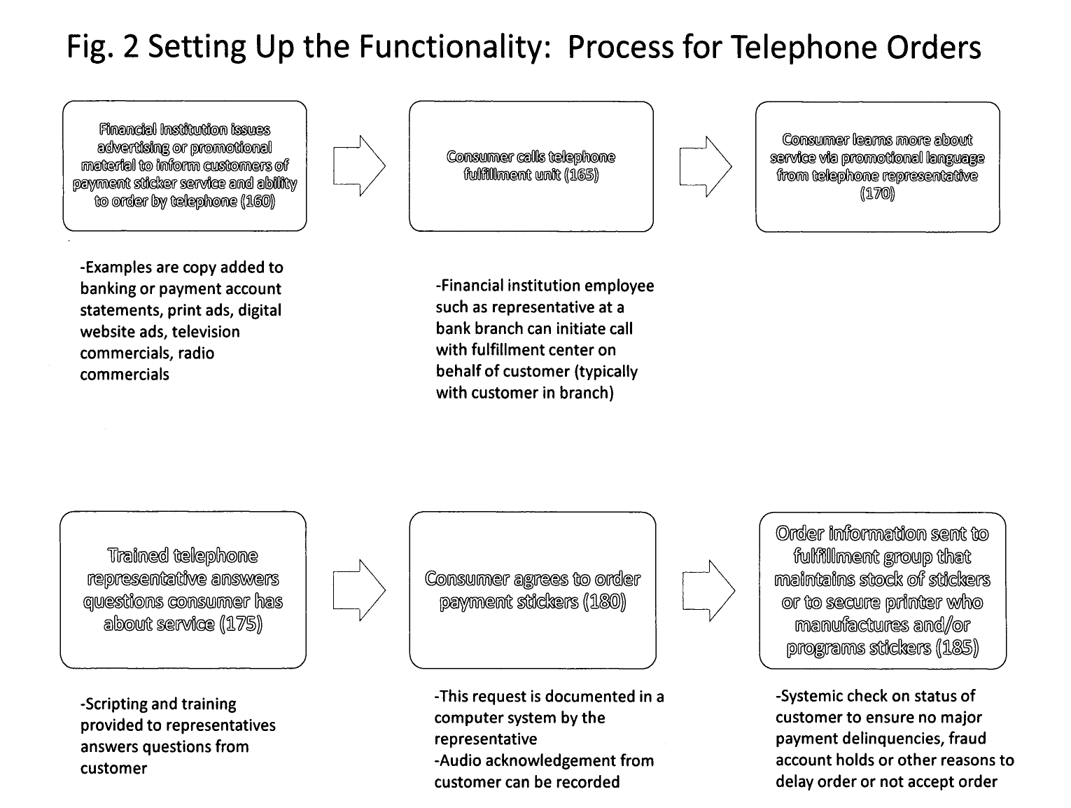

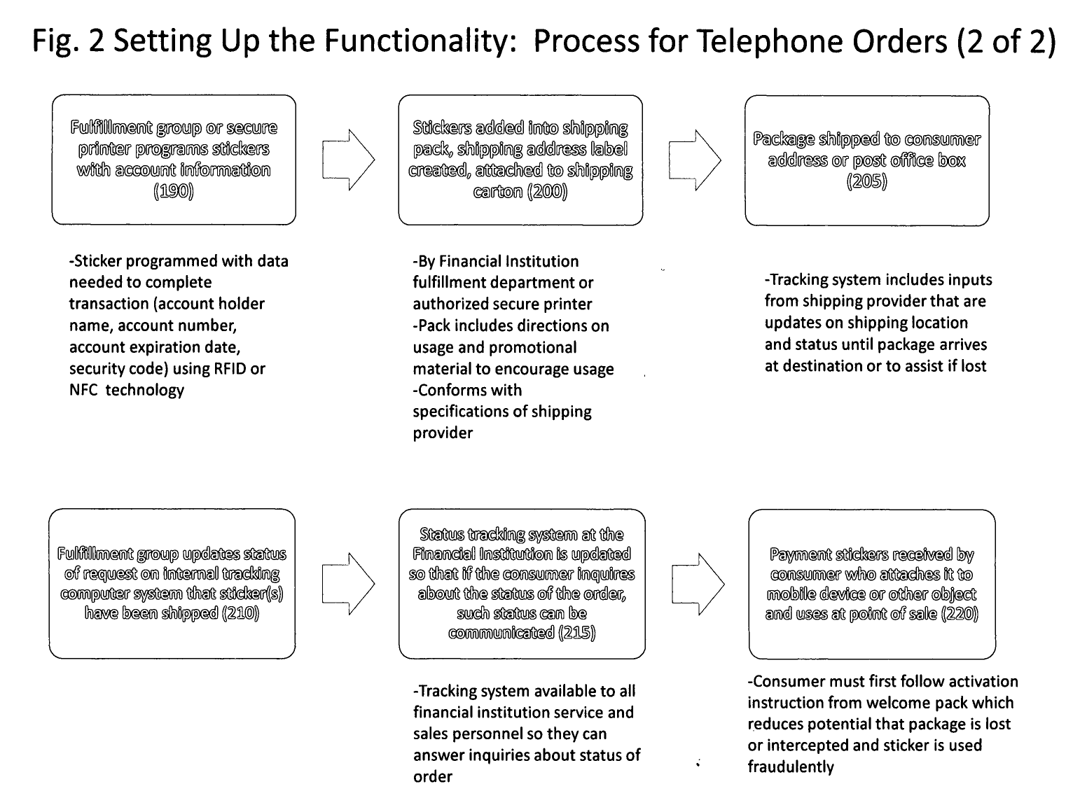

FIG. 2 illustrates how the consumer can request via telephone that the financial institution issue one or more payment stickers linked to the customer's payment account.

The financial institution makes the consumer aware of payment stickers via advertising or promotional material—and includes an inbound telephone number for use by the customer to order a payment sticker or payment stickers 160. These promotional messages can be communicated via banking or payment account statements, print ads, brand posters, digital website ads, television commercials, radio commercials and other methods.

The customer uses a telephone to contact the financial institution 165. A general purpose customer service representative or sales associate receives and places the order using electronic systems or the telephone inquiry can be routed to a dedicated, unique fulfillment team that specializes in similar orders. A Financial institution employee such as representative at a bank branch can initiate the request call on behalf of a customer. This telephone call can be made with the customer present in the branch or other location of the financial institution which allows for live identification authentication.

The customer learns more about the service directly from the financial institution representative on the telephone 170. The trained representative answers inquiries about the service and its benefits. Scripting and training provided to the representatives helps them to answer questions from customers and promote payment stickers.

The customer agrees to order a payment sticker or payment stickers linked to their payment account 175. This request is documented in a computer system by the telephone representative. The audio acknowledgement from the customer can be recorded and kept on file for access if needed during future service inquiries.

A systemic check on the status of the customer's account to ensure no major payment delinquencies, fraud account holds or other reasons to delay the order or not accept order is conducted. If such a situation is flagged by the system, a message is electronically issued to the fraud investigations unit for research and to ensure the situation is communicated to the customer. Order information is sent to the fulfillment group that maintains the stock of stickers or to a secure printer who manufactures and/or programs stickers to be used at the point of sale 180.

Information about the order including identification of the customer is sent to the financial institution's fulfillment group that maintains stock of stickers or to a secure printer, contracted by the financial institution, who manufactures payment stickers 185. The customer is identified and the fulfillment group has access to customer information needed to fulfill the order which includes name, address and payment account number. Stickers are programmed 190 to be used by the particular consumer to include account holder name, account number, account expiration date and security validation code.

Stickers are added into shipping pack by the financial institution's fulfillment department or an authorized secure printer under contract with the financial institution. A shipping address label is created and attached to shipping carton 195. The pack includes directions on usage and promotional material to encourage usage and conforms to the specifications of the shipping services provider.

The package with sticker or stickers is shipped to the consumer's specified address or a post office box 200.

The fulfillment group updates the status of the request via the internal tracking computer system that the sticker(s) have been shipped 205. The tracking system includes electronic shipping status update inputs from the shipping provider including date shipped, last location and expected delivery date—until the package arrives at destination or to assist if misplaced. The status tracking system at the Financial Institution is updated 210 so that if the consumer inquires about the status of the order, such status can be communicated and discussed. This status can be communicated via digital service inquiries such as web email, telephone or postal service delivered correspondence.

The Payment stickers are received by the customer(s) 215. As instructed in promotional material that accompanies the shipment of stickers, the customer then attaches it to a mobile device or other object and uses it at NFC-enabled point of sale terminals to make purchases. The customer must first follow activation instructions from the welcome pack which reduces the potential that the package is lost or intercepted and the sticker is used fraudulently.

The provider can elect to charge a fee to the customer for receiving the payment sticker. This can be a one-time charge for issuance of the sticker, an annual fee assessed each year that the sticker is being used by the consumer or a per-transaction fee which is assessed each time the consumer uses the payment sticker.

Managing Delivery of Stickers with Updated Expiration Dates

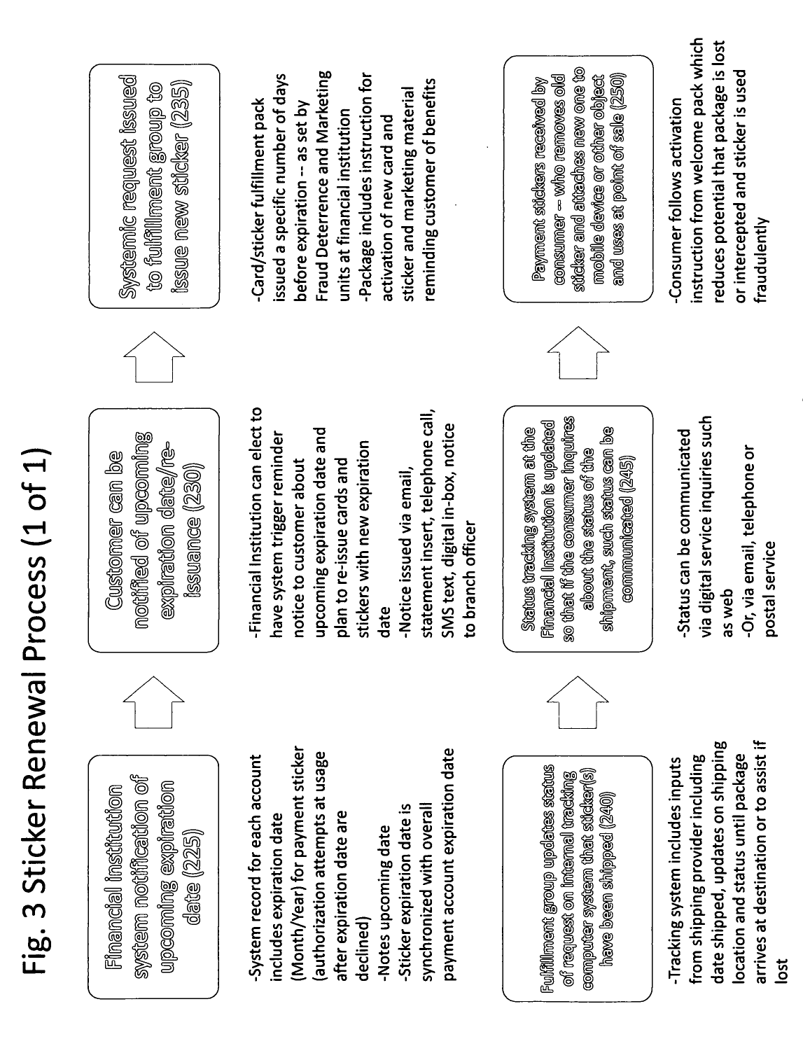

FIG. 3 is a block diagram that illustrates a method for providing a system to issue replacement payment stickers before or at expiration of the previous sticker.

A system used by the financial institution to manage and track its customer relationships issues an electronic notification of all accounts with an issued payment sticker—with an upcoming payment account expiration date 225. After the expiration date (Month/Year), transaction authorization requests by stickers linked to these accounts will typically be declined by the provider. The sticker expiration date is synchronized with overall payment account expiration date. This systemic notification is sent to the sticker fulfillment unit which can be based within the financial institution or can be a secure printer under contract.

The financial institution can first opt to issue a communication to the customer to let them know of the upcoming sticker expiration date and planned re-issuance 230. The financial institution can elect to have the system trigger a reminder notice to the customer about the upcoming expiration date and the plan to re-issue cards and stickers with a new expiration date. This notice is issued via email, statement insert, telephone call, SMS text, digital in-box or notice to a branch officer who informs the customer.

A systemic request is issued to the fulfillment group to issue a new sticker to the customer 235. The new sticker can be issued in the same package as the new card with the new expiration date. The card/sticker fulfillment pack is issued a specific number of days before expiration—as set by the Fraud Deterrence and Marketing units at the financial institution. The package includes instruction for activation of the new card and sticker and marketing material reminding the customer of program benefits.

The fulfillment group updates the status of the request on an internal tracking computer system that sticker(s) have been shipped 240. This tracking system includes inputs from the shipping provider including date shipped, updates on shipping location and status—until the package arrives at the desired destination. This also enables to financial institution to intervene if the updated sticker package is lost.

The status tracking system at the Financial Institution is updated so that if the consumer inquires about the status of the shipment, such status can be correctly communicated 245. This status can be communicated to the customer via digital customer service inquiries over the web or via email, the telephone or the letters delivered by the postal service.

The payment stickers are received by the consumer—who removes the old sticker and attaches the new one to a mobile device or other object and uses it at NFC-enabled point of sale devices 250. The consumer follows activation instruction from welcome pack which reduces potential that the package will be lost or intercepted and the sticker is used fraudulently.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

What is claimed is:

1. A system that allows consumers to learn about and order payment stickers with near field communications technology linked to a credit card/credit account, debit card/deposit account or gift card/pre-paid account directly from the account provider using internet, email, telephone or regular mail from a financial institution provider where the customer maintains a payment account and means for said provider to receive the order; fulfill the request; track the order; and ensure re-issuance of the payment stickers before expiration date.

2. The method of claim 1, wherein provider receives and documents request by customer to receive payment sticker or stickers and issues an order to provider's internal fulfillment group or secure printer under contract with the financial institution to program the sticker or stickers and ship them to the address requested by the customer.

3. The system of claim 1, wherein said means comprise a computer system to receive status inputs on the payment sticker shipment from a shipping provider and track status of the order and shipment of payment stickers on the provider's system with the purpose of achieving successful fulfillment and the ability to provide status updates at the customer's request.

4. The method of claim 1, wherein provider computer system that tracks customer information recognizes upcoming payment account expiration date and sends signal to provider's fulfillment group or secure vendor under contract with financial institution to program and issue a new payment sticker to a customer who already has one before said expiration date is reached.
